(19) United States
(12) Patent Application Publication
(10) Pub. No.: US 2021/0137233 A1
(43) Pub. Date: May 13, 2021

(54) BOOK ENCLOSURE FOR THE STORAGE, TRANSPORT AND DISPLAY OF DECORATIVE PINS

(71) Applicants: Alexander Harrison HEVIER, Winter Garden, FL (US); Sydney Paige Hevier, Winter Garden, FL (US); Julia Elise Hevier, Winter Garden, FL (US); Ronald John Hevier, JR., Winter Garden, FL (US); Rochelle Lynn Hevier, Winter Garden, FL (US)

(72) Inventors: Alexander Harrison HEVIER, Winter Garden, FL (US); Sydney Paige Hevier, Winter Garden, FL (US); Julia Elise Hevier, Winter Garden, FL (US); Ronald John Hevier, JR., Winter Garden, FL (US); Rochelle Lynn Hevier, Winter Garden, FL (US)

(21) Appl. No.: 17/151,208

(22) Filed: Jan. 17, 2021

Related U.S. Application Data
(63) Continuation-in-part of application No. 16/550,226, filed on Aug. 24, 2019, now Pat. No. 10,893,732.
Application No. 16/550,226 is a continuation of application No. 15/600,237, filed on May 19, 2017, now abandoned.

(51) Int. Cl. A45C 11/24; A45C 3/02; A45C 11/16; A45C 13/02; A45C 13/30; G09F 5/02; G09F 1/00

(52) U.S. Cl. CPC A45C 11/24; A45C 3/02; A45C 11/16; B44C 5/02; A45C 13/30; G09F 5/02; G09F 1/00; A45C 13/02

(57) ABSTRACT

An enclosure for storage, transport, and display of pins for trading includes: a front and a back connected together by a first closure mechanism, such as a zipper; and a second closure mechanism such as a zipper located on an exterior of and connecting a clear cover to the front. The enclosure defines an enclosed interior space between the front and the back in which mounting surfaces are located for pins. The cover and an outwardly facing surface of the front define another enclosed interior space having an additional mounting surface for the mounting pins to be seen through the clear cover and showcased.

### CROSS-REFERENCE TO RELATED APPLICATIONS

The present application is a continuation-in-part of U.S. patent application Ser. No. 16/550,226, now U.S. Pat. No. 10,893,732, which '226 application is a continuation of U.S. patent application Ser. No. 15/600,237, now abandoned, which '237 application published as U.S. patent appl. publication 2018/0332938. These applications, the publication, and the patent including their disclosures in their entireties are hereby incorporated by reference herein.

### BACKGROUND OF THE INVENTION

### Field of the Invention

The present invention relates to an enclosure for the storage, transport, and display of pins and, more particularly, to an enclosure for the storage, transport, and display of collectible pins for pin trading. Moreover, while preferred embodiments are intended for securing and displaying trading pins, the invention is applicable for securing and displaying lapel pins, service pins, metal badges, brooches, and other decorative pins as well as similar jewelry item having mounting posts.

### Description of the Related Art

Decorative pins have a long history originating in the military signifying the wearer's membership in a particular branch of the service or participation in a particular theatre of operation. Later, service pins were issued by businesses wishing to award employees and commemorate the number of years employed. Fraternal organizations such as the Lion's Club, The Rotary Club, and Masonic lodges often use membership pins to designate a wearer's affiliation. More recently, collectible pins have become extremely popular, with comics and movies such as Star Wars, Harry Potter, and other science fiction/fantasy genres. Collectible and decorative trading pins are descendants of the service pins and are presently used to commemorate or celebrate sporting events such as the Olympics, sports team affiliations, media creations such as those of Walt Disney, participation in charitable events, and other special awards, associations, or affiliations. Many decorative pins are colorful, highly elaborate, and festive creations that are infrequently worn due to the difficulty and cost of obtaining a replacement. Instead, these pins are often displayed, if at all, in a matted frame or shadowbox that generally has space for numerous pins.

As the collections of pins have grown, so has the need and the desire to trade pins with other collectors to complete a particular collection. Pin trading has become the most popular event in many conventions for groups collecting pins. Pin traders use lanyards to showcase and transport pin collections. Lanyards do not hold the pins well, and pins fall out and get damaged or lost. Other pin books also require pin backs to secure pins in place, requiring the user to exert much effort removing the pin back before trading. What is needed is a way to showcase the collection of the individual trading pins for trading while protecting the pins from damage resulting from contact with other pins. What is additionally needed is a way to showcase the collection of the individual trading pins for trading in a manner that securely holds the pins so that the pins are not damaged as a result of falling from lanyards or pin books, and that avoids the use of pin backs thereby making pin trading easier.

### SUMMARY OF THE INVENTION

In an aspect of the invention, an enclosure for storage, transport and display of pins for trading comprises: a front and a back connected together; a first closure mechanism located on the front and back and transitionable between a closed configuration and an opened configuration; and a second closure mechanism located on an exterior of and connecting a cover to the front and transitionable between a closed configuration and an opened configuration.

In the closed configuration of first closure mechanism, the enclosure defines an enclosed interior space between the front and the back in which enclosed interior space is located a plurality of mounting surfaces each defined by a puncturable and resilient material for the mounting of pins with post portions. In the opened configuration of the first closure mechanism, the plurality of mounting surfaces are accessible for mounting pins thereon and unmounting pins there from.

Similarly, in the closed configuration of the second closure mechanism, the cover and an outwardly facing surface of the front define an enclosed interior space having an additional mounting surface defined by a puncturable and resilient material for the mounting of pins having post portions. In the opened configuration of the second closure mechanism, the additional mounting surface is accessible for mounting pins thereon and unmounting pins there from.

In a feature, the enclosure further comprises pins mounted to said mounting surfaces.

In a feature, the enclosure further comprises a pocket for storage of pin backs of pins mounted to said mounting surfaces. The pocket preferably is located on an exterior of the enclosure and, more particularly, on an exterior of the back of the enclosure.

In a feature, the cover of the front is clear, whereby pins mounted to the additional mounting surface may be showcased when the first and second closure mechanisms are in their respective closed positions.

In a feature, an insert is located within the interior space defined by the cover and an outwardly facing surface of the front when the second closure mechanism is in the closed configuration, wherein the insert comprises the additional mounting surface.

In a feature, the first and second closure mechanisms each comprises a zipper.

In a feature, the enclosure further comprises a strap for cross-body or shoulder portage of the enclosure.

In another aspect, a book enclosure for storage, transport, and display of pins for trading comprises a front page and a back page connected together; a first closure mechanism located on the front and back pages and transitionable between a closed configuration and an opened configuration; and a second closure mechanism located on an exterior of and connecting a cover to the front page and transitionable between a closed configuration and an opened configuration.

When the first closure mechanism is in the closed configuration, the book enclosure defines an enclosed interior space between the front and the back pages in which enclosed interior space is located a plurality of mounting surfaces, each mounting surface being defined by a puncturable and resilient material for the mounting of pins with post portions. When the first closure mechanism is in the opened configuration, the plurality of mounting surfaces are accessible for mounting pins thereon and unmounting pins there from.

Similarly, when the second closure mechanism is in the closed configuration, the cover and an outwardly facing surface of the front page define an enclosed interior space having an additional mounting surface defined by a puncturable and resilient material for the mounting of pins having post portions. When the second closure mechanism is in the opened configuration, the additional mounting surface is accessible for mounting pins thereon and unmounting pins there from.

In features, the book enclosure further comprises pins mounted to a said mounting surface; and a pocket for storage of pin backs of said pins, wherein the pocket is located on an exterior of the book enclosure.

In a feature, the cover is clear, whereby pins mounted to the additional mounting surface may be showcased when the book enclosure is closed.

In a feature, the outwardly facing surface of the front page comprises the additional mounting surface.

In a feature, the first and second closure mechanisms each comprises a zipper.

In a feature, the book enclosure further comprises a strap for cross-body or shoulder portage of the book enclosure.

In a feature, the book enclosure further comprises a protective cover extending between opposing mounting surfaces within the interior space.

In a feature, the book enclosure further comprises interior pages located between the front and the back pages, each interior page comprising a said mounting surface. A protective cover preferably extends between opposing mounting surfaces of said interior pages.

### DESCRIPTION OF THE DRAWINGS

For a more complete understanding of the present invention, reference is now made to the drawings, wherein:

FIG. 1 is a front view of an enclosure in accordance with a preferred embodiment of the present invention;

FIG. 2 a back perspective view of the enclosure of FIG. 1;

FIG. 3 is a back view of the enclosure of FIG. 1;

FIG. 4 is a side view of the enclosure of FIG. 1 when zipped in a closed configuration;

FIG. 5 is a view of the exterior of the enclosure of FIG. 1 when unzipped and in an opened configuration;

FIG. 6 is a view of the interior of the enclosure of FIG. 1 when unzipped and in the opened configuration prior to inserting any decorative pins into the pages of the enclosure;

FIG. 7 is another view of the interior of the enclosure of FIG. 1 when unzipped and in the opened configuration after inserting decorative pins into the pages of the enclosure;

FIG. 8 is a view illustrating the clear cover of the front page of the enclosure of FIG. 1, wherein the zipper of the clear cover of the front page is in an opened configuration with the cover folded back for mounting and unmounting of decorative pins to an exteriorly facing surface of the front page;

FIG. 9 is a view illustrating the clear cover of the front page of FIG. 10 after inserting the decorative pins into the exteriorly facing surface of the front page and moving the zipper to a closed configuration of the enclosure in order to secure the pins;

FIG. 10 is a front view of the enclosure of FIG. 1 after attachment of a removable strap;

FIG. 11 is a side view of another preferred enclosure when zipped in a closed configuration;

FIG. 12 is a view of the interior of the enclosure of FIG. 11;

FIG. 13 is a front view of another preferred embodiment of an enclosure;

FIG. 14 is a back view of the enclosure of FIG. 13 and highlights that the enclosure of FIG. 13 includes backpack straps for carriage of the enclosure on a person's back;

FIG. 15 is a view of handle straps of the enclosure of FIG. 13; and

FIG. 16 is a view of a puncturable insert of the enclosure of FIG. 13, which is received within the enclosable space defined between the protective cover and the exteriorly facing surface of the front page for encasing the puncturable insert.

### DETAILED DESCRIPTION OF THE INVENTION

The following detailed description sets forth preferred embodiments of the invention considered to be the best modes of practicing the invention. The description is not to be taken in a limiting sense, but is made merely for the purpose of illustrating general aspects and features of the invention through detailed descriptions of the preferred embodiments.

With reference now to FIGS. 1-4, a preferred embodiment of an enclosure 100 in accordance with the invention is seen when zipped closed. In particular, FIG. 1 is a front view of the enclosure 100, which enclosure resembles a book; FIG. 2 a back perspective view of the enclosure 100; FIG. 3 is a back view of the enclosure 100; and FIG. 4 is a side view of the enclosure 100.

As seen in these figures, the enclosure 100 comprises a front page 102 and a back page 104 that are joined together by zipper 106 in a closed configuration. The zipper 106 preferably is a U-type zipper closure, although other securing means may be used including, for example, hook-and-loop fasteners or slider seals, or such other equivalent mechanisms When zipped, the enclosure securely retains any items contained therein.

Conversely, when unzipped, the enclosure 100 can be laid open and contents accessed as seen, e.g., in FIGS. 5-7. Specifically, FIG. 5 is a view of the exterior of the enclosure 100 when unzipped and in an opened configuration; FIG. 5 is a view of the interior of the enclosure 100 when unzipped and in the opened configuration prior to inserting any decorative pins onto the mounting surfaces of the pages of the enclosure; and FIG. 6 is another view of the interior of the enclosure 100 after inserting decorative pins onto the mounting surfaces of the pages of the enclosure.

Preferably, the mounting surfaces of the pages have a material through which the decorative pins are puncturable and which material is self-healing so that posts of various decorative pins may be repeatedly pierced through the material with the material remaining supportive of the pin posts time after time. The material preferably is self-healing and deformable, and preferably is made of natural or synthetic rubber, ethylene vinyl acetate, corrugated plastic, or other such material that can accommodate multiple piercings so that the decorative pins can be changed frequently without affecting usability. The material of each puncturable page at least partially conforms to the interior shape of the enclosure and defines a mounting surface for the decorative pins that are pierced by the one or more posts of each decorative pin.

As seen more particularly in FIG. 6, the front page 102 and the back page 104 have interior mounting surfaces 108 that are puncturable and resilient and are made of a material for the piercing there through of post portions of decorative pins. These interior mounting surfaces 108 preferably are raised or contoured, and holes preferably are provided in these interior mounting surfaces as part of a decorative pattern, such as the star pattern 109 seen in the drawings. Such a raised decorative surface provides an attractive background for display of the pints. Alternatively, no decorative pattern is provided and the surfaces are not raised. The self-healing deformable and resilient material of the mounting surfaces can be made of material such as natural or synthetic rubber or other such synthetic or natural material that can accommodate multiple piercings so that the decorative pins can be changed frequently without affecting usability.

As further seen in FIG. 6, the enclosure 100 preferably comprises a protective interior cover 110 located between the opposing, interior mounting surfaces 108. As evident in FIG. 7—which is a view after inserting decorative pins onto the mounting surfaces 108 of pages 102,104 of the enclosure 100, the interior cover 110 protects opposing pins 111 mounted on the opposing, interior mounting surfaces 108 from contacting and damaging each other. The protective interior cover 110 further preferably conforms to the interior shape of the pages of the enclosure 100. In alternative embodiment, a protective interior cover is provided for each interior mounting surface of a page. The pins mounted on the pages inside the enclosure 100 then are secured within the enclosure 100 through the use of the zipper 106 that joins the front page 102 and back page 104 in the closed configuration.

The back of the enclosure 100 further comprises a pouch enclosure in the form of a mesh pocket 103 (e.g., FIG. 3) for the storage of pin backs, which are not used in mounting the pins to the mounting surfaces of the enclosure 100.

Referring again to FIG. 1, the enclosure 100 includes a second zipper 112 used to secure a cover 101 of protective material to the front page 102. The zipper 112 preferably is a U-type zipper closure, although other securing means may be used including, for example, hook-and-loop fasteners or slider seals, or such other equivalent mechanisms When zipped, the enclosure securely retains any items contained therein. The cover 101 preferably is clear or translucent, whereby the cover 101 of the front page forms a viewing window permitting decorative pins mounted onto an exteriorly facing surface 116 (FIG. 8) of the front page 102 for display, even when the enclosure 100 is zipped closed via zipper 106 and zipper 112. FIG. 8 illustrates the clear cover 101 of the front page 102 of the enclosure 100, wherein the zipper 112 of the clear cover 101 of the front page 102 is partially open for mounting of the decorative pins 108 to the exteriorly facing surface 116 of the front page 106.

In contrast, FIG. 9 illustrates the clear cover 101 of the front page 102 after inserting decorative pins 114 onto the exteriorly facing mounting surface 116 of the front page 102 and closing the zipper 112 to secure the pins so mounted on the exterior of the front page 102. Thus, as can be seen from FIGS. 8-9, the zipper 112 is used to unfasten and reposition the cover 101, whereby decorative pins 114 can be mounted to the exteriorly facing surface 116 of the front page 102 and then secured by closing the cover 101 over the pins 114 so mounted, all while exhibiting those pins 114 so mounted and secured.

The front page 102 further preferable has a raised portion forming a ridge 115 (perhaps best seen in FIGS. 8 and 9) to which the cover 101 attaches via the zipper 112. The ridge preferably defines a border that encompasses the front display area of the exhibited pins 114 when mounted to the exteriorly facing surface 116 of the front page 102. The ridge 115 preferably defines a rectangular border with rounded corners; however, the border may be any other shape, including round, polygonal, or elliptical.

FIG. 10 is a front view of the enclosure 100 illustrating the attachment of a removable strap 118 to hooks 117 of the enclosure 100. The enclosure 100 thus is configurable for handsfree carriage by positioning the strap 118 on or over one's shoulder or for cross-body portage while exhibiting mounted pins 114. The strap 118 further may be used to hang the enclosure 100 on a wall or other surface for display of mounted pins 114.

Referring to FIG. 11, this is a side view of another preferred enclosure 200, which has two intermediate interior pages 222,224 located between the front page 202 and the back page 204. As seen in FIG. 11, zipper 206 zips together front page 204 and back page 204 thereby securing intermediate pages 222,224 therebetween.

FIG. 12 is a view of the interior of enclosure 200 for receiving and securely retaining decorative pins 228 on mounting surfaces 216 of pages 202,204,222,224 of the enclosure 200. As seen in FIG. 11, enclosure 200 is an example of an enclosure that does not include a cover or exterior display for exhibiting pins when the enclosure is zipped-up in a closed configuration. As seen in FIG. 12, a protective interior cover 210 is located between the opposing mounting surfaces 204 of the innermost pages 222,224 for protecting opposing pins from contacting and damaging each other. In alternative embodiments, the enclosure has more than two interior pages for accommodating a larger number of decorative pins; such an enclosure may have, for example, four interior pages with a protective page located between the two most innermost pages in order to prevent opposing decorative pins mounted thereto form potential damage from contact therebetween.

In other embodiments, such as enclosure 300 of FIGS. 13-16, a puncturable insert 316 with a decorative, raised surface for mounting of pins is insertable into an enclosable space defined between a protective cover 301 and an exteriorly facing surface 319 of a front page 306 for encasing the puncturable insert 316 when the cover 301 is closed via zipper 312 (FIG. 16). The clear cover 301 serves as a window for viewing pins mounted to the exterior facing surface of the insert 316 even when zipper 306 (FIG. 15) secures the enclosure 300 in a closed configuration.

It furthermore will be appreciated that enclosure 300 is generally similar to enclosure 100 and 200, with the primary exception being the removable insert 316 and the backpack straps 325 (FIG. 14), which are attached to the back and enable the enclosure 300 to be carried on a person's back. Enclosure 300 also includes two mesh pockets 303 on the straps 325.

As will be appreciated from the forgoing detailed description, a preferred display enclosure resembles in some ways a book and contains therein pages which have a puncturable material for receiving posts of decorative pins and which material is self-healing so that posts of decorative pins may be repeatedly pierced through the material with the material remaining supportive of the pin posts time after time. The material preferably is made of natural or synthetic rubber, ethylene vinyl acetate, corrugated plastic, or other such material that can accommodate multiple piercings so that mounted decorative pins can be changed frequently without affecting usability. Preferably, each puncturable page at least partially conforms to the interior shape of the enclosure and defines a mounting surface for the decorative pins that are pierced by the one or more post portions of each decorative pin. The pins mounted on the pages inside the enclosure preferably can be secured within the enclosure through the use of a zipper that joins together the front page and the back page, and any pages therebetween, when the enclosure is zipped up into a closed configuration.

Additionally, in preferred embodiments, the front page has a clear, repositionable, protective cover that forms a viewing window permitting decorative pins to be showcased that are mounted onto an exteriorly facing additional mounting surface of the front page. A zipper is used to open the cover whereby those decorative pins can be mounted to the exteriorly facing mounting surface of the front page and then secured by closing the cover over the pins mounted thereon. The front page preferable has a raised portion forming a ridge to which the cover attaches with the zipper, thereby providing sufficient space for the decorative pins and insert if applicable. The ridge preferably defines a border that encompasses the display area of the showcased pins, and more particularly, the ridge preferably defines a rectangular border; however, the border may be any other shape, including round, polygonal, or elliptical. The clear cover serves as a window for viewing pins mounted therein when the cover is zipped-up on the front page with the enclosure in the closed configuration.

What is claimed is:

1. An enclosure for storage, transport, and display of pins for trading, comprising:
(a) a front and a back connected together;
(b) a first closure mechanism located on the front and back and transitionable between a closed configuration and an opened configuration; and
(c) a second closure mechanism located on an exterior of and connecting a cover to the front and transitionable between a closed configuration and an opened configuration;
(d) wherein, when in the closed configuration of the first closure mechanism, the enclosure defines an enclosed interior space between the front and the back in which enclosed interior space is located a plurality of mounting surfaces each defined by a puncturable and resilient material for the mounting of pins with post portions, and when in the opened configuration of the first closure mechanism, the plurality of mounting surfaces are accessible for mounting pins thereon and unmounting pins there from; and
(e) wherein, when in the closed configuration of the second closure mechanism, the cover and an outwardly facing surface of the front define an enclosed interior space having an additional mounting surface defined by a puncturable and resilient material for the mounting of pins having post portions, and when in the opened configuration of the second closure mechanism, the additional mounting surface is accessible for mounting pins thereon and unmounting pins there from.

2. The enclosure of claim 1, further comprising pins mounted to a said mounting surface and a pocket for storage of pin backs of said pins.

3. The enclosure of claim 2, wherein the pocket is located on an exterior side of the back of the enclosure.

4. The enclosure of claim 1, wherein the cover is clear, whereby pins mounted to the additional mounting surface may be showcased when the first and second closure mechanisms are in their respective closed positions.

5. The enclosure of claim 1, wherein an insert is located within the interior space defined by the cover and an outwardly facing surface of the front when the second closure mechanism is in the closed configuration, the insert an insert is located within the interior space defined by the cover and an outwardly facing surface of the front when the second closure mechanism is in the closed configuration, the insert comprising the additional mounting surface.

6. The enclosure of claim 1, wherein the first and second closure mechanisms each comprises a zipper. The enclosure of claim 1, further comprising a strap for cross-body or shoulder portage of the enclosure.

8. The enclosure of claim 1, further comprising a protective cover extending between opposing mounting surfaces within the interior space.

9. The enclosure of claim 1, further comprising pages located between the front and the back. each page comprising a said mounting surface.

10. The enclosure of claim 9, further comprising a protective cover extending between opposing mounting surfaces of the pages within the interior space.

11. A pin book for storage, transport, and display of pins for trading, comprising:
(a) a front page and a back page connected together;
(b) a first closure mechanism located on the front and back pages and transitionable between a closed configuration and an opened configuration, in which closed configuration the pin book defines an enclosed interior space between the front and the back pages in which enclosed interior space is located a plurality of mounting surfaces each defined by a puncturable and resilient material for the mounting of pins with post portions, and in which opened configuration the plurality of mounting surfaces are accessible for mounting pins thereon and unmounting pins there from; and
(c) a second closure mechanism located on an exterior of and connecting a cover to the front page and transitionable between a closed configuration and an opened configuration, in which closed configuration the cover and an outwardly facing surface of the front page define an enclosed interior space having an additional mounting surface defined by a puncturable and resilient material for the mounting of pins having post portions, and in which opened configuration the additional mounting surface is accessible for mounting pins thereon and unmounting pins there from.

12. The pin book of claim 11, further comprising pins mounted to a said mounting surface and a pocket for storage of pin backs of said pins.

13. The pin book of claim 12, wherein the pocket is located on an exterior side of the back page.

14. The pin book of claim 11, wherein the cover is clear, whereby pins mounted to the additional mounting surface may be displayed when the book enclosure is closed.

15. The pin book of claim 11, wherein the outwardly facing surface of the front page comprises the additional mounting surface.

16. The pin book of claim 11, wherein the first and second closure mechanisms each comprises a zipper.

17. The pin book of claim 11, further comprising a strap for cross-body or shoulder portage of the enclosure.

18. The pin book of claim 11, further comprising a protective cover extending between opposing mounting surfaces within the interior space.

19. The pin book of claim 11, further comprising interior pages located between the front and the back pages, each interior page comprising a said mounting surface.

20. The pin book of claim 19, further comprising a protective cover extending between opposing mounting surfaces of said interior pages.
